(19) United States
(12) Patent Application Publication
(10) Pub. No.: US 2023/0364699 A1
(43) Pub. Date: Nov. 16, 2023

(54) WELDER GENERATOR SYSTEMS WITH MULTIPLE ARCS

(71) Applicant: Earlbeck Corporation, Baltimore, MD (US)

(72) Inventor: Andrew HESS, Huntingtown, MD (US)

(73) Assignee: Earlbeck Corporation, Baltimore, MD (US)

(21) Appl. No.: 17/742,353

(22) Filed: May 11, 2022

(51) Int. Cl. B23K 9/10; F02B 63/04

(52) U.S. Cl. CPC B23K 9/1068; F02B 63/04

(57) ABSTRACT

The invention of the present disclosure avails to those in the field of welding a dual power-dual arc welder generator that allows for the separation of an ICE-powered generator from a connected welding machine, which has not been achieved previously. Currently, welding machines of ICE-powered systems may not be decoupled from the generator for use with local primary electrical power is available, and the generator is cannot power a dual arc system. The invention includes a plurality of inverter power welding machines, such as two for a dual arc system, wherein each inverter power welding machine is powered by a single ICE-powered generator. This enables a user of the system to power two welding machines using a single ICE-powered generator, which in turn enables the use of less equipment for dual arc welding in areas where primary electrical power is not available.

### STATEMENT REGARDING FEDERALLY SPONSORED RESEARCH OR DEVELOPMENT

The invention was made without the benefit of federal funding.

### BACKGROUND OF THE INVENTION

It is known to those of ordinary skill in the art in the field of welding that welding in a location where there is no available primary electrical power requires that a welding machine be powered by a generator that employs an internal combustion engine (ICE). These systems are known in the industry as engine driven welders, which are sold as stand-alone pieces of equipment that generate their own power and usually include auxiliary power that may be used to power other equipment. These machines produce alternating current (AC) power sufficient to power the welding machine. As will be recognized by most people, these systems consume fossil fuels, release emissions into the atmosphere, generate noise pollution, occupy a large geographic footprint, and provide only one welding arc. To wit, the increasing demand for automobiles powered partially or completely by electricity generated independently of an ICE demonstrates that this is a societal and environmental problem for which solutions must be developed. Currently, when an ICE is used to power a welding machine, the welder cannot be operated independently of the ICE, as the welder and ICE are part of a single unit. Even if primary electrical power is available the ICE must be run in order to power the welder, leading to unnecessary environmental impact.

Thus, there is a long felt need in the art for a welding system that allows for separation of the ICE-powered generator from the welding machine in this situation. There is a need in the art for technology that enables a technician in the field to operate the welding machine to disconnect from the ICE-powered generator and rely on primary electrical power to power the machine, thereby reducing fossil fuel consumption, eliminating undesirable emissions and reducing noise pollution. An exemplar of a currently available system consists of an ICE, and a welder/generator mounted to a common frame and producing only one welding arc. The ICE is hard coupled to the welder/generator such that the ICE and welder cannot be separated or used independently. The desire for more versatile systems with reduced environmental impact, along with other objects of the invention, will become evident from the disclosure that follows.

### BRIEF SUMMARY OF THE INVENTION

The invention involves a dual power-dual arc welder generator (DP-DAWG) that allows for the separation of an ICE-powered generator from a welding machine, which cannot be achieved using existing solutions. A dual power system as described herein allows the welding machine to be separated from the ICE-powered generator in areas where primary electrical power suitable for powering the welding machine is available and accessible. In addition to the ability to separate the ICE from the welding system when operating in environments where primary electrical power may be used, the DP-DAWG offers the added benefit of significantly reducing the geographic footprint of dual arc systems by eliminating the existing need in the art for two separate ICE-powered generators, which are needed in the current state of the art in order to produce two welding arcs. A system of the present invention employs an output connection panel that enables a plurality, for example two, as in the case of a dual arc system, of welding machines having internal power inverters that convert AC generator power to direct current (DC) power, then back to AC power at a higher cycle than the AC power produced by the ICE-powered generator. This added benefit makes dual arc welding possible in spaces that cannot currently accommodate them, leading to additional efficiencies as compared to existing systems.

In an exemplary embodiment of the present invention, a single ICE-powered generator having an output connection panel with a plurality of power receptacles, each for powering a single arc welder with internal inverter power conversion capability, may be used as a power supply. Each welder in the system is configured with a customized power adapter cable capable of connecting to a power receptacle of the ICE and drawing power from the running ICE to the corresponding welder using an appropriately sized power cable for electrical conduction. The AC-DC-AC power inversion capability allows for smaller transformers and lower input power requirements, all within a welding machine. Welding machines with this capability are not currently used in the field and may confer environmental and other benefits compared to existing systems as explained above.

### BRIEF DESCRIPTION OF THE DRAWINGS

FIG. 1 illustrates an exemplary embodiment of a DP-DAWG system according to the present disclosure.

### DETAILED DESCRIPTION OF THE INVENTION

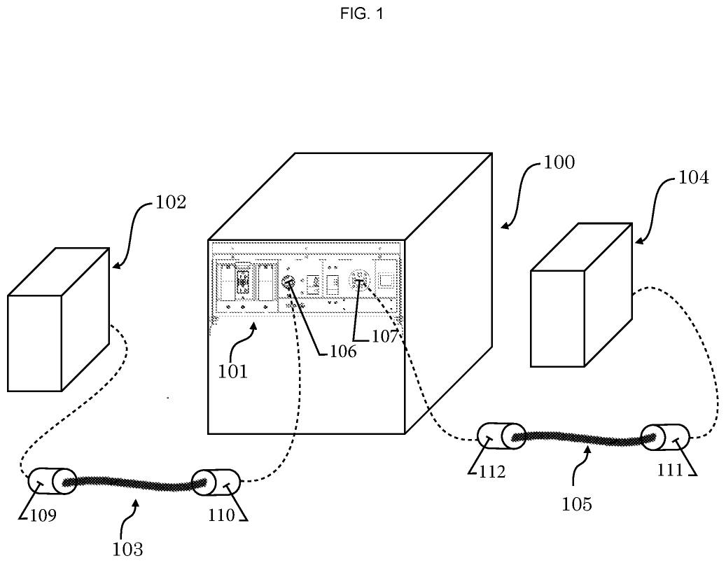

FIG. 1 illustrates an exemplary embodiment of the invention, namely a dual power-dual arc welder generator (DP-DAWG) that allows for the separation of an ICE-powered generator from a welding machine, which cannot be achieved using engine driven welders as described above. A dual power system as described herein may leverage power inverter technology in order to arrive at an inverter welding power supply internal to a welding machine, which can be separated from the ICE-powered generator in areas where primary electrical power suitable for powering the welding machine is available and accessible. Current ICE-powered welding machines are hard coupled together and do not allow for separation. In preferred embodiments, two power inverter welding machines are used, capable converting AC power from an ICE-powered generator to DC, then back to AC, useful with lower power transformers.

To explain FIG. 1 in more detail, the drawing illustrates an exemplary embodiment of the invention comprising a DP-DAWG that allows for separation of an ICE-powered generator from a welding machine, which cannot be achieved with engine driven welders currently on the market. An ICE-powered generator 100 according to the present disclosure is equipped with an output connection panel 101 suitable for connecting multiple welders, shown as 102 and 104 in the DP-DAWG configuration of FIG. 1. As will be known to one of ordinary skill in the art, different welding machines may be configured with different types of input connections. As such, a suitable power cable 103, 105 may be configured with any number of different types of welder plugs 109, 111 in order to fit a particular type of welder, such as but not limited to metal inert gas (MIG), tungsten inert gas (TIG) or stick welders, as will be familiar to one of ordinary skill in the art.

Continuing with FIG. 1, receptacles 106, 107 of an output connection panel 101 may assume various configurations in order to accommodate various plugs 110, 112 designed to allow an ICE to power multiple welders 102, 104 of various types. In addition to the ability to separate the ICE from the welding machine when operating in environments where primary electrical power may be used, the DP-DAWG offers the added benefit of a significantly smaller system by virtue of the separation capability described above, as welders 102, 104 may be extended into areas distant from the ICE 100 using power cables 103, 105 of suitable length. For dual arc systems, two welding arcs may be created using a single ICE-powered generator when no primary electricity is available, eliminating the existing need in the art for two separate ICE-powered generators to produce two welding arcs. This benefit makes dual arc welding possible in spaces that cannot currently accommodate more than one engine driven welder, leading to additional efficiencies as compared to existing systems. The explanation that follows will be appreciated by one of ordinary skill in the art.

An ICE-powered generator 100 having an output connection panel 101 with a plurality of receptacles 106, 107 enables connection to multiple welding machines 102 and 104, such as inverter power welders. Custom power adapter cables 103, 105 may be used to connect the ICE-powered generator 100 to the inverter power welding machines 102 and 104. Inverter power welding machines may be used with power from a single ICE-powered generator 100, which represents a significant advantage over existing systems, and may be separated from the ICE-powered generator and used with a primary electricity source. Existing power cords 103, 105 may be customized in order to allow for connections between the ICE-powered generator 100 and two welding machines 102 and 104.

As one of ordinary skill in the art will understand, various ICE-powered generators and power inverters may be equipped with a variety of different types of receptacles and power cords 103, 105 may be configured with appropriate plugs 109, 110, 111 to facilitate secure connections. When inverters are used, the inverter of each inverter power welding machine does not output inverted power as is common in the art when inverters are used. The present invention enables the conversion of 60 cycle AC power to DC power, which then flows through the inverter circuit to produce much higher cycle AC power. The transformer that creates the welding output power may be much smaller than what is typically used, thus reducing power consumption dramatically.

As will be evident to one of ordinary skill in the art, cables that are known in the art may be employed for the purpose of transferring power between an ICE-powered generator and a welding machine by customizing the end connectors to be compatible with receptacles on ICE-powered generators and inverter power welding machine power supplies. It will also be evident that cables having suitable electrical qualities such as impedance, capacitance and conductivity may be selected depending on the application. Connectors and cables may be selected from commercially available off-the-shelf offerings and customized for use with the invention, which offers the benefits already discussed as compared to the current state of the art offerings in the field of welding.

Similarly, an ICE-powered generator for use with the current invention may be purchased on the open market or built to specification for use with the present invention, and may be adapted for operation according to the present disclosure as needed. A selected generator must provide acceptable power in terms of amperage to power two welding machines as described herein, which will be understood by one of ordinary skill in the art. Size and power are selected based on these requirements. However, welders as contemplated for use in various embodiments do not draw significant amounts of current. By way of example and not limitation, a 10.8 kilowatt ICE-powered generator may be used in most applications where the invention of the present disclosure would be used.

It follows from the foregoing that the invention described herein addresses many shortcomings of currently available engine driven welders wherein an ICE is hard coupled to a welder, limiting the ability to rely on local primary electrical power and power multiple welding arcs from a single generator. By packaging welders—inverter welders or otherwise—with stand alone generators, multiple welders may be run from a single generator at once, or alternatively, may be plugged into a local power source on any job site having live outlets available. These and other environmental advantages of the invention of the present disclosure will be evident to those of ordinary skill in the art.

What is claimed:

1. A welder generator system, the system comprising:
an internal combustion engine (ICE)-powered generator having an output connection panel electrically coupled to a plurality of welding machines;
wherein the plurality of welding machines is powered by the ICE powered generator simultaneously.

2. The welder generator system according to claim 1, wherein the output connection panel is configured with a plurality of receptacles for receiving an output plug of a power cable coupled to each of the plurality of welding machines via an input plug of a corresponding power cable.

3. The welder generator system according to claim 1, wherein each of the plurality of welding machines is configured with a power inverter and a transformer;
wherein the power inverter converts external alternating current (AC) power drawn from the ICE-powered generator to direct current (DC) power then inverts the DC power to internal AC power;
wherein the internal AC power is drawn from a transformer and used to power the corresponding welding machine.

4. The welder generator system according to claim 1, wherein each output plug may be removed from its corresponding receptacle on the output connection panel and plugged into a local primary electrical power source.

5. The welder generator system of claim 3, wherein the external AC power has a higher cycle frequency than the internal AC power.

6. A welder generator system according to claim 1, wherein the system is a dual power-dual arc welder generator (DP-DAWG) system, wherein the plurality of welding machines is two welding machines.

7. The welder generator system of claim 1, wherein the ICE-powered generator may be decoupled from the plurality of welding machines.

8. The DP-DAWG system of claim 6, wherein the ICE-powered generator may be decoupled from the plurality of welding machines.

9. The DP-DAWG system according to claim 6, wherein each of the two welding machines is configured with a power inverter and a transformer;
wherein the power inverter converts external alternating current (AC) power drawn from the ICE-powered generator to direct current (DC) power then inverts the DC power to internal AC power;
wherein the internal AC power is drawn from a transformer and used to power the corresponding welding machine.

10. The DP-DAWG system of claim 9, wherein the external AC power has a higher cycle frequency than the internal AC power.
